(19) United States
(12) Patent Application Publication
(10) Pub. No.: US 2026/0061767 A1
(43) Pub. Date: Mar. 5, 2026

(54) PRINTING SYSTEM

(71) Applicant: SEIKO EPSON CORPORATION, Tokyo (JP)

(72) Inventors: Katsuya ASAMOTO, MATSUMOTO-SHI (JP); Tsuneyuki SASAKI, MATSUMOTO-SHI (JP)

(21) Appl. No.: 19/317,667

(22) Filed: Sep. 3, 2025

(30) Foreign Application Priority Data
Sep. 4, 2024 (JP) 2024-152091

(51) Int. Cl. B41J 29/377; B41J 11/00; B41J 15/04; B41J 29/17

(52) U.S. Cl. CPC B41J 29/377; B41J 11/0024; B41J 15/048; B41J 29/17

(57) ABSTRACT

A printing system 1 includes a printing device 20 having a transport section 29 that transports a medium M, a printing section 27 that prints an image by ejecting ink onto the medium M transported by the transport section 29, and a housing 21 having a first space 22 in which the printing section 27 is arranged; a drying device 10 including a drying oven 14 into which the medium M on which the image is printed by the printing section 27 enters, and a heating section 15 that is arranged in the drying oven 14 and heats the medium M; and a flow path section 13 configured to discharge gas inside the drying oven 14 to outside the drying oven 14, that is a first flow path section 13A that connects the drying oven 14 and the first space 22.

The present application is based on, and claims priority from JP Application Serial Number 2024-152091, filed September 4, 2024, the disclosure of which is hereby incorporated by reference herein in its entirety.

### BACKGROUND

### 1. Technical Field

The present disclosure relates to a printing system.

### 2. Related Art

In the related art, various printing systems that print an image on a medium by ejecting ink have been used. Among these, there is a printing system including a temperature adjustment mechanism that adjusts the temperature of ink in order to stably eject the ink in a printing section that ejects the ink. For example, an inkjet recording device is disclosed in which a plurality of heating sections is provided in an ink supply direction in order to set the ink temperature to an appropriate range in JP-A-2008-110588. Note that by adjusting the temperature of the ink, the landing accuracy of the ink can be improved, and the waveform of the voltage applied to the element for ejecting the ink can be simplified. On the other hand, there is a printing system including a drying device that, in a subsequent stage of the printing device that prints an image on a medium by ejecting ink, dries that ink that was ejected onto a medium by a printing device.

In the related art, the printing system including a temperature adjustment mechanism that adjusts the temperature of ink, a dedicated heating section is provided to set the ink temperature to an appropriate range, and thus power consumption occurs in such a dedicated heating section. Therefore, in such a printing system, there is a tendency that large power consumption occurs in the entire printing system.

### SUMMARY

A printing system according to the present disclosure to solve above-described problem includes a printing device including a transport section that transports a medium, a printing section that prints an image by ejecting ink onto the medium transported by the transport section, and a housing having a first space in which the printing section is arranged; a drying device including a drying oven into which enters the medium on which the image printed by the printing section, and a heating section that is arranged in the drying oven and that heats the medium; and a first flow path section that connects the drying oven and the first space and that is configured to discharge gas inside the drying oven to outside the drying oven.

### BRIEF DESCRIPTION OF THE DRAWINGS

FIG. 1 is a schematic side view illustrating a printing system according to a first embodiment of the present disclosure.

FIG. 2 is a schematic side view illustrating a printing system according to a second embodiment of the present disclosure.

### DESCRIPTION OF EMBODIMENTS

First, the present disclosure will be described in outline.

A printing system according to a first aspect of the present disclosure for solving the above problem includes a printing device including a transport section that transports a medium, a printing section that prints an image by ejecting ink onto the medium transported by the transport section, and a housing having a first space in which the printing section is arranged; a drying device including a drying oven into which enters the medium on which the image printed by the printing section, and a heating section that is arranged in the drying oven and that heats the medium; and a first flow path section that connects the drying oven and the first space and that is configured to discharge gas inside the drying oven to outside the drying oven.

According to the present aspect, the first flow path section that is a flow path section of gas for discharging gas in the drying oven to outside the drying oven and connects the drying oven and the first space is provided. In other words, the temperature of the ink can be adjusted by using the heated gas generated in the drying device. Therefore, it is possible to eliminate the need to provide a dedicated heating section, and it is possible to adjust the temperature of the ink with low power consumption when considering the printing system as a whole.

A printing system according to a second aspect of the present disclosure is the printing system according to the first aspect that further includes a blower fan that is arranged in the flow path section and that generates air flow to discharge gas from the drying oven to outside the drying oven.

According to the present aspect, the blower fan is provided which is arranged in the flow path section and generates the air flow for discharging gas in the drying oven to outside the drying oven. With such a configuration, for example, the heated gas generated in the drying device can be efficiently sent to the first space, and the temperature of the ink can be efficiently adjusted.

According to a third aspect of the present disclosure, the printing system is provided in an aspect that is dependent on one of the first or second aspects, further includes a check valve that is arranged in the flow path section and that is configured to prevent backflow of gas from outside of the drying oven back into the drying oven.

According to the present aspect, the check valve is arranged in the flow path section. It is configured to prevent backflow of gas from outside the drying oven to the inside of the drying oven. With such a configuration, for example, the heated gas generated in the drying device can be efficiently sent to the first space, and the temperature of the ink can be efficiently adjusted.

According to a fourth aspect of the present disclosure, the printing system is provided in an aspect that is dependent on any one of the first to third aspects, further includes an exhaust duct configured to discharge gas from the first space and a second flow path section that is part of the flow path section and that connects the drying oven and the exhaust duct.

According to the present aspect, an exhaust duct configured to discharge gas from the first space and the second flow path section that couples the drying oven with the exhaust duct are provided. With such a configuration, the heated gas generated in the drying device can be not only sent to the first space but also discharged via the second flow path section without being sent to the first space. Therefore, it is possible to suppress the first space from being excessively heated, and it is possible to adjust the temperature of the ink with high accuracy.

According to a fifth aspect of the present disclosure, the printing system is provided in an aspect that is dependent the fourth aspect, further includes an adjustment section configured to adjust flow rates of gas flowing from the drying oven to the first flow path section and from the drying oven to the second flow path section.

According to the present aspect, the adjustment section that adjusts the flow rate of gas flowing from the drying oven to the first flow path section and the flow rate of gas flowing from the drying oven to the second flow path section is provided. With such a configuration, it is possible to eliminate the need for the user to manually adjust the flow rate of gas flowing through the first flow path section and the flow rate of gas flowing through the second flow path section, and it is possible to automatically adjust the flow rate of gas flowing through the first flow path section and the flow rate of gas flowing through the second flow path section. Therefore, usability can be improved.

According to a sixth aspect of the present disclosure, the printing system is provided in an aspect that is dependent the fifth aspect, includes the first temperature sensor that detects the temperature of the first space, wherein the adjustment section is configured to adjust flow rates of gas flowing through the first flow path section and the second flow path section based on a detection result of the first temperature sensor.

According to the present aspect, the first temperature sensor that detects the temperature of the first space is provided and the adjustment section is configured to adjust flow rates of gas flowing through the first flow path section and the second flow path section based on a detection result of the first temperature sensor. With such a configuration, the flow rate of gas flowing through the first flow path section and the flow rate of gas flowing through the second flow path section can be adjusted with particularly high accuracy. Therefore, it is possible to suppress the first space from being excessively heated, and it is possible to adjust the temperature of the ink with particularly high accuracy.

The printing system according to a seventh aspect of the present disclosure, in an embodiment dependent on the fifth aspect, includes a second temperature sensor that detects a temperature of the ink in the printing section, wherein the adjustment section adjusts a flow rate of gas flowing through the first flow path section and a flow rate of gas flowing through the second flow path section based on a detection result of the second temperature sensor.

According to the present aspect, the second temperature sensor that detects the temperature of the ink in the printing section is provided, and the adjustment section adjusts the flow rate of gas flowing through the first flow path section and the flow rate of gas flowing through the second flow path section based on the detection result of the second temperature sensor. With such a configuration, the flow rate of gas flowing through the first flow path section and the flow rate of gas flowing through the second flow path section can be adjusted with particularly high accuracy. Therefore, it is possible to suppress the first space from being excessively heated, and it is possible to adjust the temperature of the ink with particularly high accuracy.

According to a eighth aspect of the present disclosure, the printing system is provided in an aspect that is dependent on any one of the first to seventh aspects, the transport section includes a transport belt that is arranged in the first space and that includes an adhesive layer to which an adhesive is applied and gas discharged from the first flow path section in the first space is blown toward the transport belt.

According to the present aspect, the transport section includes the transport belt that is disposed in the first space and includes the adhesive layer to which the adhesive is applied. With such a configuration, for example, a medium such as a large and soft fabric can be stably transported. Gas discharged from the first flow path section in the first space is blown toward the transport belt. With this configuration, the temperature of the adhesive disposed on the transport belt can also be raised, and the adhesiveness of the adhesive can be improved to improve the transport stability by the transport belt.

According to a ninth aspect of the present disclosure, the printing system is provided in an aspect that is dependent the eighth aspect, further including a washing section that cleans the transport belt on the downstream side of the printing section in the movement direction of the transport belt, wherein gas discharged from the first flow path section is blown to a position between the printing section and the washing section in the movement direction of the transport belt.

According to the present aspect, a washing section that cleans the transport belt on the downstream side of the printing section in the movement direction of a transport belt, wherein gas discharged from the first flow path section is blown to a position between the printing section and the washing section in the movement direction of the transport belt. With such a configuration, it is possible to blow gas moistened with the volatile component of the ink sent from the drying oven to the first space to the transport belt between the printing section and the washing section, that is, before cleaning in the washing section, and it is possible to improve the cleaning effect in the washing section.

### FIRST EMBODIMENT

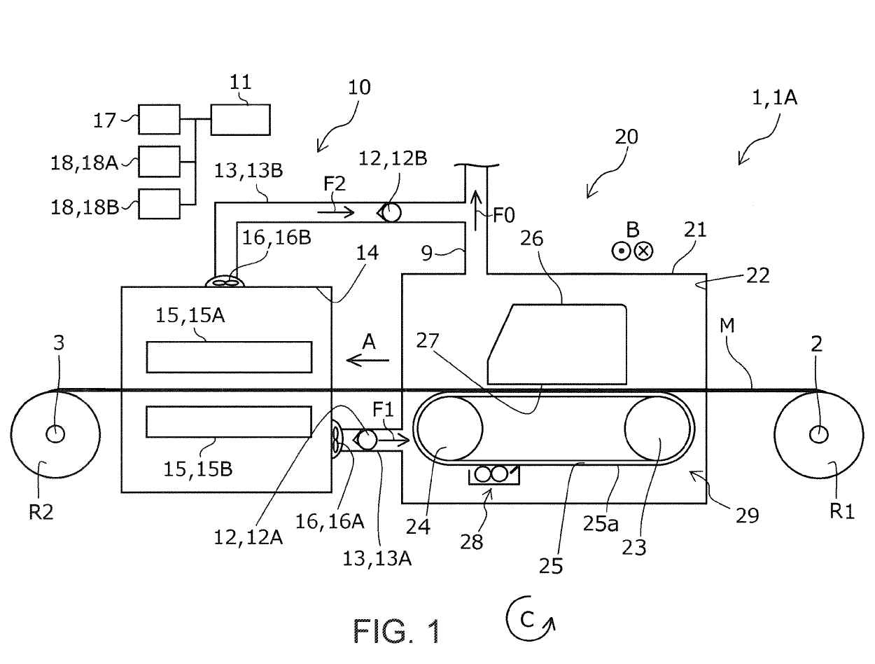

Hereinafter, an embodiment according to the present disclosure will be described with reference to the drawings. First, an overview of a printing system 1A of one of a example about a printing system 1 of the present disclosure including a printing device 20 and a drying device 10 will be described with reference to FIG. 1.

As illustrated in FIG. 1, the printing system 1A of the present embodiment includes a holding section 2 capable of rotatably holding a roll body R1 in which medium M, such as fabric, is wound in roll form. The printing system 1A also includes the printing device 20 that has a transport section 29 that transports the medium M, a head 27 as a printing section that prints an image by ejecting ink onto the medium M transported by the transport section 29, and a housing 21 having a first space 22 in which the head 27 is arranged. The printing system 1A also includes the drying device 10 that has a drying oven 14 into which the medium M on which an image is printed by the head 27 enters, and a heating section 15 that is arranged in the drying oven 14 and that heats the medium M. The printing system 1A further includes a winding section 3 that can form a roll body R2 by winding in roll form the medium M, on which printing has been performed by the printing device 20 and that has had ink dried by the drying device 10.

The holding section 2 holds a paper tube that constitutes a rotation shaft of the roll body R1 and rotates in a rotation direction C to feed the medium M from the roll body R1 to the transport section 29 of the printing device 20. The holding section 2 may be configured separately from the printing device 20 but may be a part of the constituent members of the printing device 20.

The printing device 20 of the present embodiment is an inkjet printer capable of forming an image on a medium M by ejecting ink, which is a liquid, in the form of droplets. The printing device 20 includes, within the first space 22 inside the housing 21, the transport section 29 comprising a driven roller 23 located upstream in the transport direction A of the medium M, a drive roller 24 located downstream in the transport direction A, and a transport belt 25, which is an endless belt spanning between the driven roller 23 and the drive roller 24. Here, the transport belt 25 is an adhesive belt having an outer peripheral surface 25a, to which an adhesive is applied. This surface serves as the support surface for the medium M and that is located on the outer side surface of the belt. An exhaust duct 9 for discharging gas from the first space 22 is connected to the housing 21.

As illustrated in FIG. 1, in the transport section 29, the medium M is transported while being supported by the transport belt 25 in a state in which the medium M sticks to the outer peripheral surface 25a. In the printing device 20 of the present embodiment, a medium support region that supports the medium M on the transport belt 25 is an upper region spanning between the driven roller 23 and the drive roller 24. The drive roller 24 is a roller that rotates in a rotation direction C by driving force of a motor (not illustrated), and the driven roller 23 is a roller that rotates by being driven by the rotation of the transport belt 25 according to the rotation of the drive roller 24.

In other words, the movement direction of the transport belt 25 when transporting the medium M is the rotation direction C, and the movement direction of the transport belt 25 in the medium supporting region is the transport direction A. However, it is also possible to rotate the drive roller 24 in the direction opposite to the rotation direction C and move the transport belt 25 in the direction opposite to the rotation direction C, except when transporting the medium M.

The printing device 20 of the present embodiment includes a carriage 26 that can reciprocate in the width direction B of the transport belt 25, and the head 27 attached to the carriage 26. The head 27 is a printing section that can form an image by ejecting liquid ink onto the medium M transported in the transport direction A based on the print data.

The printing device 20 of the present embodiment can form an image by ejecting ink from the head 27 onto the transported medium M while reciprocating the carriage 26 in the width direction B intersecting the transport direction A. With the carriage 26 configured in this manner, the printing device 20 of the present embodiment is capable of forming a desired image on the medium M by repeatedly transporting the medium M in the transport direction A by a predetermined amount and ejecting ink while moving the carriage 26 in the width direction B while the medium M is held stationary. However, the configuration of the printing section is not particularly limited. For example, a so-called line head in which nozzles that eject ink are provided over the entire width direction B of the medium M may be used as the printing section.

When the medium M on which an image is formed by ejecting ink from the head 27 is ejected from the printing device 20 of the present embodiment, the medium M is sent to the drying device 10 that is provided at a stage subsequent to the printing device 20 of the present embodiment in the transport direction A and volatilizes a component of the ink ejected onto the medium M. The drying device 10 of the present embodiment constitutes the printing system 1 together with the printing device 20 as described above.

A material for textile printing can preferably be used as the medium M. The material for textile printing refers to a fabric, clothes, other clothing products, or the like to be textile printed. The fabric includes woven, knitted, or non-woven textiles made from natural fibers such as cotton, silk, and wool, synthetic fibers such as nylon, or composite fibers that combine these materials. The clothes and other clothing products include T-shirts, handkerchiefs, scarves, towels, handbags, cloth bags, and furniture such as curtains, sheets, and bed covers after sewing, as well as fabrics before and after cutting that exist as parts in a state before sewing. However, in addition to the above-mentioned materials for textile printing, dedicated inkjet recording papers such as plain paper, high-quality paper, and glossy paper can also be used.

As illustrated in FIG. 1, the drying device 10 of the present embodiment includes the heating section 15 that heats the medium M, and the drying oven 14 in which the heating section 15 is arranged and that dries the medium M. Two heating sections 15 are provided in the transport path of the medium M, and specifically, a first heating section 15A is arranged at a position facing the front side of the medium M on the side where the ink is ejected from the heads 27, and a second heating section 15B is arranged at a position facing the rear side of the medium M on the opposite side to the front side. In the present embodiment, both the first heating section 15A and the second heating section 15B are configured to be able to blow heated air streams onto the medium M. However, the configuration of the heating section 15 is not particularly limited and may be a configuration in which the medium M is irradiated with infrared rays, a heater formed of a heating wire, or the like.

The drying oven 14 is arranged with two blower fans 16 that generate air flow for discharging gas from the drying oven 14 to outside the drying oven 14. A first blower fan 16A of the blower fan 16 is arranged at a drying device 10 side inlet of a first flow path section 13A, which is the gas flow path section 13 that connects the drying oven 14 of the drying device 10 and the first space 22 of the printing device 20 together. Here, the outlet of the first flow path section 13A on the printing device 20 side is arranged at a position facing the transport belt 25. By driving the first blower fan 16A, air flows in the direction F1 from the drying device 10 to the printing device 20 in the first flow path section 13A.

A second blower fan 16B of the blower fan 16 is arranged at a drying device 10 side inlet of a second flow path section 13B, which is the gas flow path section 13 that connects the drying oven 14 of the drying device 10 to the exhaust duct 9, which is connected to the printing device 20. By driving the second blower fan 16B, air flows in the direction F2 from the drying device 10 to the exhaust duct 9 in the second flow path section 13B. In the exhaust duct 9, the air flows in the direction F0 toward outside the printing device 20 and the drying device 10.

The printing system 1A of the present embodiment is configured to have a check valve 12 installed in the flow path section 13 to prevent backflow of air. Specifically, a first check valve 12A is arranged in the first flow path section 13A, and a second check valve 12B is arranged in the second flow path section 13B.

As described above, the printing system 1A of the present embodiment includes the winding section 3. The winding section 3 holds a paper tube as a rotation shaft for forming the roll body R2 and rotates in a rotation direction C to wind the medium M around the paper tube, thereby forming the roll body R2. The winding section 3 may be configured separately from the drying device 10 but may be a part of the constituent members of the drying device 10.

As described above, the printing system 1A of the present embodiment includes the printing device 20 and the drying device 10 as described above. Also, it includes the first flow path section 13A that is the gas flow path section 13 for discharging gas in the drying oven 14 of the drying device 10 to outside of the drying oven 14 and that connects the drying oven 14 and the first space 22 of the printing device 20. With this configuration, the heated gas in the drying oven 14 can be sent to the first space 22 in which the head 27 to which the ink is supplied is arranged, via the first flow path section 13A.

Therefore, the printing system 1A of the present embodiment is configured to be able to adjust the temperature of the ink in the printing device 20 by using gas in the drying oven 14, that is, the heated gas generated in the drying device 10. Therefore, the printing system 1A of the present embodiment can eliminate the need to arrange a dedicated heating section, and when the printing system 1A is considered as a whole, the printing system 1A has a configuration capable of adjusting the temperature of the ink with low electric power consumption. For example, the temperature of the ink can be adjusted to about 32 ± 3ºC. By adjusting the temperature of the ink, it is possible to simplify the waveform of the voltage applied to the element for ejecting the ink provided in the head 27.

Furthermore, with such a configuration, the interior of the first space 22 can be kept at a constant temperature. This helps suppress the expansion and contraction of constituent members located inside the first space 22, such as the head 27 and the frame of the printing device 20, thereby improving ink ejection accuracy. Although the printing device 20 of the present embodiment is not provided, a mechanism capable of adjusting the temperature of the head 27 or the like, such as a cooling device or a heating device, may be separately provided.

In the printing system 1 having a general configuration, when the drying device 10 and the printing device 20 are installed close to each other, the heat generated in the drying device 10 heats the entire printing device 20, and there is a concern that the constituent members of the printing device 20 may thermally expand and thermally deform. Therefore, in the related art, the drying device 10 and the printing device 20 are arranged with a predetermined interval between them. However, by adopting the configuration of the printing system 1A of the present embodiment, the heat generated in the drying device 10 can heat only the inside of the first space 22, not the entire printing device 20. Therefore, the drying device 10 and the printing device 20 can be installed close to each other, and the arrangement space of the printing system 1 can be a space-saving design.

As described above, the printing system 1A of the present embodiment includes the blower fan 16 that is arranged in the flow path section 13 and that generates air flow for discharging gas in the drying oven 14 to outside the drying oven 14. Specifically, the first blower fan 16A is arranged in the first flow path section 13A and generates air flow for discharging gas in the drying oven 14 to outside the drying oven 14, and the second blower fan 16B is arranged in the second flow path section 13B and generates air flow for discharging gas in the drying oven 14 to outside the drying oven 14.

With such a configuration, the printing system 1A of the present embodiment can efficiently send the heated gas generated in the drying device 10 to the first space 22 and can efficiently adjust the temperature of the ink. Gas can be efficiently discharged to outside the drying oven 14 through the second flow path section 13B so that the temperature in the drying oven 14 does not become too high.

As described above, the printing system 1A of the present embodiment includes the check valve 12. This valve is arranged in the flow path section 13 and prevents gas from flowing back from outside the drying oven 14 into it. Specifically, the first check valve 12A is arranged in the first flow path section 13A and configured to suppress backflow of gas from outside the drying oven 14 back into the drying oven 14, and the second check valve 12B is arranged in the second flow path section 13B and configured to suppress backflow of gas from outside the drying oven 14 back into the drying oven 14.

With such a configuration, the printing system 1A of the present embodiment can efficiently send the heated gas generated in the drying device 10 to the first space 22 and can efficiently adjust the temperature of the ink. Gas can be efficiently discharged to outside the drying oven 14 through the second flow path section 13B so that the temperature in the drying oven 14 does not become too high. With such a configuration, it is possible to prevent gas having a low temperature from flowing into the drying oven 14 from the first space 22 or the exhaust duct 9. That is, it is possible to prevent a decrease in drying efficiency due to a decrease in temperature in the drying oven 14.

As described above, the printing system 1A of the present embodiment includes the exhaust duct 9 that discharges gas in the first space 22, and the second flow path section 13B that constitutes the flow path section 13 and that connects the drying oven 14 and the exhaust duct 9. With such a configuration, the printing system 1A of the present embodiment can not only send the heated gas generated in the drying device 10 to the first space 22, but also discharge gas via the second flow path section 13B without sending gas to the first space 22. Therefore, it is possible to suppress the first space 22 from being excessively heated, and it is possible to adjust the temperature of the ink with particularly high accuracy.

Here, as illustrated in FIG. 1, the printing system 1A of the present embodiment includes a control section 11 capable of controlling the entire printing system 1A. The control section 11 serves as an adjustment section that adjusts the driving of each of the first blower fan 16A and the second blower fan 16B to adjust the flow amount of gas flowing from the drying oven 14 to the first flow path section 13A and the flow amount of gas flowing from the drying oven 14 to the second flow path section 13B.

In present embodiment, the printing system 1A is equipped with the control section 11 that functions as a adjustment section, thereby eliminating the need for the user to manually adjust gas flow rates through the first flow path section 13A and the second flow path section 13B. As a result, the system can automatically regulate gas flow rates through both the first flow path section 13A and second flow path section 13B. Therefore, the printing system 1A of the present embodiment can improve usability.

As illustrated in FIG. 1, the printing system 1A of the present embodiment includes a blower fan drive section 17 that is electrically connected to the control section 11 and capable of controlling the operation of the blower fan 16. The blower fan drive section 17 can adjust the driving of each of the first blower fan 16A and the second blower fan 16B.

As illustrated in FIG. 1, the printing system 1A of the present embodiment includes a temperature sensor 18 that is electrically connected to the control section 11 and are capable of detecting temperature. Specifically, the temperature sensor 18 includes a first temperature sensor 18A that detects the temperature of the first space 22. Based on the detection result of the first temperature sensor 18A, the control section 11 can adjust the flow amount of gas flowing through the first flow path section 13A and the flow amount of gas flowing through the second flow path section 13B.

With such a configuration, the printing system 1A of the present embodiment can adjust the flow amount of gas flowing through the first flow path section 13A and the flow amount of gas flowing through the second flow path section 13B with particularly high accuracy. Therefore, the printing system 1A of the present embodiment can suppress the first space 22 from being excessively heated, and can adjust the temperature of the ink with particularly high accuracy.

There is no particular limitation on the method of adjusting the flow amount of gas flowing through the first flow path section 13A and the flow amount of gas flowing through the second flow path section 13B. The adjustment of gas flow rate through the first flow path section 13A and gas flow rate through the second flow path section 13B may be achieved, as in the present embodiment, by varying the drive levels of the first blower fan 16A and the second blower fan 16B. However, for example, it is also possible to adopt a configuration in which shutters or the like are separately provided in the first flow path section 13A and the second flow path section 13B, and the opening levels of these shutters are adjusted.

The printing system 1A of the present embodiment includes a second temperature sensor 18B that detects the temperature of the ink in the head 27 as the temperature sensor 18. The control section 11 can adjust the flow amount of gas flowing through the first flow path section 13A and the flow amount of gas flowing through the second flow path section 13B based on the detection result of the second temperature sensor 18B.

With such a configuration, the printing system 1A of the present embodiment can adjust the flow amount of gas flowing through the first flow path section 13A and the flow amount of gas flowing through the second flow path section 13B with particularly high accuracy. Therefore, from this point of view, the printing system 1A of the present embodiment can suppress the first space 22 from being excessively heated, and can adjust the temperature of the ink with particularly high accuracy.

In the printing system 1A of the present embodiment, the internal temperature of the drying oven 14 can be set arbitrarily by the user. Therefore, when the detection results of the first temperature sensor 18A and the second temperature sensor 18B exceed the thresholds, the flow amount of gas flowing through the first flow path section 13A and the flow amount of gas flowing through the second flow path section 13B are automatically changed. When the flow amount of gas flowing through the first flow path section 13A is increased, the temperature of the first space 22 is increased, and when the flow amount of gas flowing through the first flow path section 13A is decreased, the temperature of the first space 22 is decreased.

As described above, in the printing system 1A of the present embodiment, the transport section 29 includes the transport belt 25 that is arranged in the first space 22 and that has the adhesive layer to which adhesive is applied. Gas discharged from the first flow path section 13A in the first space 22 is blown toward the outer peripheral surface 25a of the transport belt 25.

The printing system 1A of the present embodiment has a configuration in which the transport belt 25 having an adhesive layer in which an adhesive is applied to the outer peripheral surface 25a is included as the transport section 29, and thus, for example, medium M such as large and soft fabrics can be stably transported. In addition, since gas discharged from the first flow path section 13A in the first space 22 is blown toward the outer peripheral surface 25a of the transport belt 25, the temperature of the adhesive disposed on the transport belt 25 can also be increased, and the adhesiveness of the adhesive can be improved, thereby improving the transport safety of the transport belt 25.

As illustrated in FIG. 1, the printing system 1A of the present embodiment includes a washing section 28 that cleans the transport belt 25 downstream of the head 27 in the rotation direction C which is the movement direction of the transport belt 25. The position to which gas that was discharged from the first flow path section 13A is blown is between the head 27 and the washing section 28 in the movement direction of the transport belt 25.

With such a configuration, the printing system 1A of the present embodiment can blow gas moistened with the volatile components of the ink sent from the drying oven 14 to the first space 22 to the transport belt 25 between the head 27 and the washing section 28, that is, before washing in the washing section 28, and can improve the washing effect in the washing section 28.

The washing section 28 of the present embodiment includes a container containing a washing liquid, a rotating brush partially soaked in the washing liquid and partially in contact with the outer peripheral surface 25a, and a wiper that wipes the washing liquid adhering to the outer peripheral surface 25a. The printing system 1A of the present embodiment has the washing section 28 having such a configuration, and is configured to blow gas wetted with the volatile components of the ink sent from the drying oven 14 to the first space 22 to the transport belt 25 before washing in the washing section 28, and thus, is configured to be capable of efficiently collecting the volatile components of the ink without causing dew condensation at a place not intended by the user. However, the configuration of the washing section 28 is not particularly limited. However, by improving the cleaning effect in the washing section 28 with such a configuration, for example, the number of rotating brushes can be reduced to reduce costs.

### SECOND EMBODIMENT

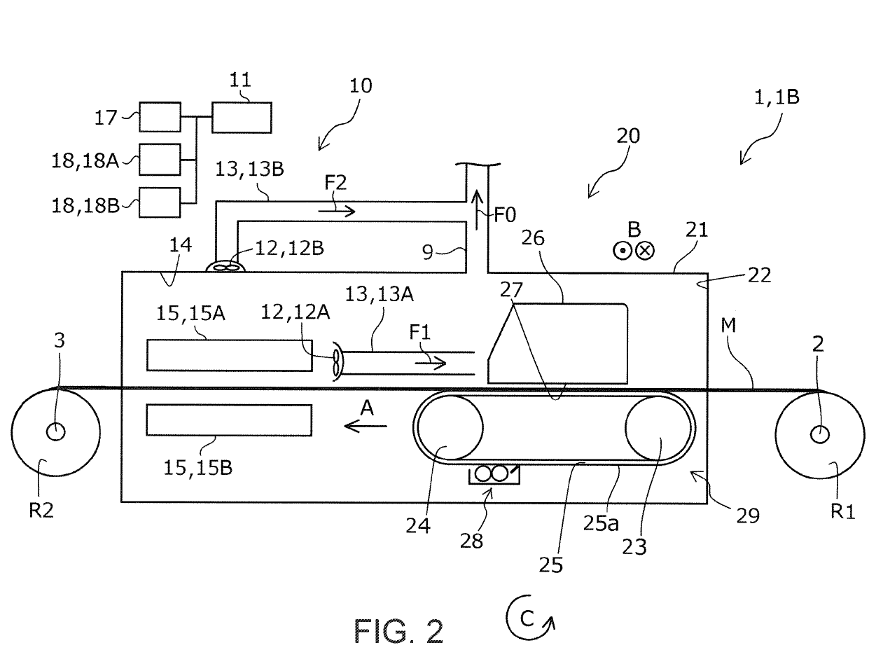

Next, a printing system 1B according to a second embodiment will be described with reference to FIG. 2. FIG. 2 is a diagram corresponding to FIG. 1 in the printing system 1A of the first embodiment. In FIG. 2, the same reference numerals are used to designate the same constituent members as those in the first embodiment, and the detailed description thereof will be omitted. The printing system 1B of the present embodiment has the same configuration as the printing system 1A of the first embodiment except for the parts described below. Therefore, the printing system 1B of the present embodiment has the same features as the printing system 1A of the first embodiment except for the parts described below.

As illustrated in FIG. 2, in the printing system 1B of the present embodiment, the printing device 20 and the drying device 10 are integrally configured. With such a configuration, gas heated by the drying device 10 can be efficiently sent to the first space 22 without releasing heat outside. Therefore, the configuration of the gas flow path section 13 and the like can be simplified, for example, the check valve 12 can be omitted, and the cost of the printing system 1 can be reduced in addition to miniaturization of the printing system 1.

Here, the printing device 20 and the drying device 10 being integrally configured means that the boundary between the printing device 20 and the drying device 10 is not clear, and also means that the boundary between the printing device 20 and the drying device 10 is clear and at least a part of the printing device 20 and the drying device 10 is connected. The configuration of the gas flow path section 13 is not particularly limited. The gas flow path section 13 may have a tubular configuration such as a duct or may have a simple hole-like configuration in which the gas flow path section 13 is provided in a wall. Further, the first space 22 and the drying oven 14 may not have a clear boundary therebetween, and the air current may flow from the drying device 10 side to the printing device 20 side, that is, from the drying oven 14 side to the first space 22 side.

The present disclosure is not limited to the above-described embodiments, and various modifications are possible within the scope of the disclosure described in the claims, and it is needless to say that they are also included in the scope of the present disclosure. For example, a mist generating mechanism that generates mist capable of cooling the head 27 may be provided, or a wiper that wipes the head 27 may be configured to be capable of cooling the head 27.

What is claimed is:

1. A printing system comprising:
a printing device including a transport section that transports a medium, a printing section that prints an image by ejecting ink onto the medium transported by the transport section, and a housing having a first space in which the printing section is arranged;
a drying device including a drying oven into which enters the medium on which the image printed by the printing section, and a heating section that is arranged in the drying oven and that heats the medium; and
a first flow path section that connects the drying oven and the first space and that is configured to discharge gas inside the drying oven to outside the drying oven.

2. The printing system according to claim 1 further comprising:
a blower fan that is arranged in the flow path section and that generates air flow to discharge gas from the drying oven to outside the drying oven.

3. The printing system according to claim 1 further comprising:
a check valve that is arranged in the flow path section and that is configured to prevent backflow of gas from outside of the drying oven back into the drying oven.

4. The printing system according to claim 1 further comprising:
an exhaust duct configured to discharge gas from the first space and
a second flow path section that is part of the flow path section and that connects the drying oven and the exhaust duct.

5. The printing system according to claim 4 further comprising:
an adjustment section configured to adjust flow rates of gas flowing from the drying oven to the first flow path section and from the drying oven to the second flow path section.

6. The printing system according to claim 5 further comprising:
a first temperature sensor that detects the temperature of the first space, wherein
the adjustment section is configured to adjust flow rates of gas flowing through the first flow path section and the second flow path section based on a detection result of the first temperature sensor.

7. The printing system according to claim 5 further comprising:
a second temperature sensor that detects a temperature of the ink in the printing section, wherein
the adjustment section adjusts a flow rate of gas flowing through the first flow path section and a flow rate of gas flowing through the second flow path section based on a detection result of the second temperature sensor.

8. The printing system according to claim 1 wherein
the transport section includes a transport belt that is arranged in the first space and that includes an adhesive layer to which an adhesive is applied and
gas discharged from the first flow path section in the first space is blown toward the transport belt.

9. The printing system according to claim 8 further comprising:
a washing section that cleans the transport belt on the downstream side of the printing section in the movement direction of the transport belt, wherein
gas discharged from the first flow path section is blown to a position between the printing section and the washing section in the movement direction of the transport belt.
